(19) United States
(12) Patent Application Publication
(10) Pub. No.: US 2003/0112276 A1
(43) Pub. Date: Jun. 19, 2003

(54) User augmentation of content

(76) Inventors: Clement Lau, Los Altos, CA (US); Richter A. Rafey, Santa Clara, CA (US); Ravi Gauba, Fremont, CA (US); Annie Wang, San Jose, CA (US); Klaus Hofrichter, Santa Clara, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/028,569

(22) Filed: Dec. 19, 2001

(51) Int. Cl. G09G 5/00

(52) U.S. Cl. 345/764

(57) ABSTRACT

Multimedia content presented to a user may be augmented by the user. The content may be annotated with information received from the user. Additionally or alternatively, the multimedia content may be bookmarked by the user and sources with related information are automatically found and associated with the content.

### FIELD OF THE INVENTION

The invention relates generally to multimedia content and in particular to the augmenting of such content by a user.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 2000, Sony Electronics, Inc., All Rights Reserved.

### BACKGROUND

The viewing of multimedia content by consumers is generally a passive experience. A consumer is presented with the content, watches it, but typically has no way of adding information to the content and sharing the added information with others. In a rich multimedia entertainment environment, a consumer may want to add personalized information (for example, his critiques of the content, his own list of most interesting scenes of a content, etc.) to make their viewing a more active experience. In a home networking environment, the consumer may want to share the added information with other members of the household. In a wide area networking environment, e.g., the Internet, a consumer may want to share the added information with people who are interested in the same content.

Many consumers also desire the ability to assign “bookmark” a particular part of a content they are viewing so that they may later conveniently retrieve the content. In a rich multimedia environment, a consumer also may want to access other sources related to the bookmarked content, e.g. where the bookmarked content is a screenshot of an actress, a related source could be another bookmark to a movie with the same actress. Currently, the bookmark retrieves only the bookmarked content and the consumer must manually search for related information and manually manage the search results.

### SUMMARY OF THE INVENTION

Multimedia content presented to a user may be augmented by the user. The content may be annotated with information received from the user. Additionally or alternatively, the multimedia content may be bookmarked by the user and sources with related information are automatically found and associated with the content.

### BRIEF DESCRIPTION OF THE DRAWINGS

The present invention is illustrated by way of example and not limitation in the figures of the accompanying drawings, in which like references indicate similar elements and in which:

FIG. 1 illustrates an system overview of one embodiment of the present invention.

FIG. 2 illustrates one embodiment of logical blocks for an augmentation manager of FIG. 1.

FIG. 3 is a diagram of a computer environment suitable for practicing the invention.

FIGS. 4A-C are flow diagrams of methods performed by the augmentation manager of FIG. 2.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional and other changes may be made without departing from the scope of the present invention. The following detailed description is, therefore, not to be taken in a limiting sense, and the scope of the present invention is defined only by the appended claims.

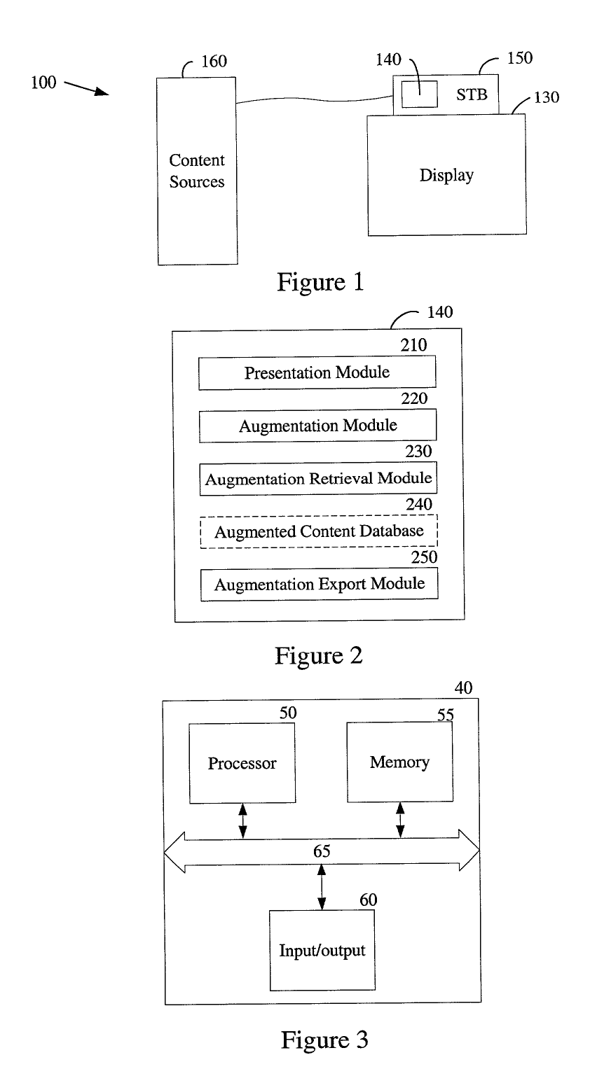

FIG. 1 shows a system overview of one embodiment of the present invention. The system 100 includes a display 130, such as a television monitor, an augmentation manager 140, a set top box 150, and content sources 160 accessible to the set top box 150. Content sources 160 may include but are not limited to nodes on a local area network, the Internet, sources of profile information and on-site media system devices. While the augmentation manager 140 is illustrated as a component of the set top box 150, it will be appreciated that it also may be integrated into the display 130, or connected to the set top box 150 or display 130 as a separate component. Content sources 160 may be accessed by the augmentation manager 140 using any conventional means (e.g. optical, wired, wireless transmission) through which a communication connection may be made. The augmentation manager 140 associates annotations, bookmarks and related sources, or any combination as augmentations to selected content.

The augmentation manager 140 allows consumers to enter an annotation to content being presented to them. The annotation is associated with a particular content selection and may contain any information the consumer chooses to enter (e.g., his critique of the content, the list of his favorite scenes, a related URL link regarding the content, etc.). The annotation is added to a list of existing annotations for that particular content. The augmentation manager 140 may optionally export the annotated content for immediate or subsequent use by an external application (e.g., posting the annotated content in an area accessible by others with similar interests).

The augmentation manager 140 also allows a consumer to assign a bookmark to content and automatically searches for related information from sources determined by the consumer's user profile (e.g., specific areas of interest), network connectivity (e.g., local or wide area network connections), and the availability of devices associated with an on-site media system (e.g., Media Suponjii™ enabled devices from Sony Electronics). A list of any sources with related information found by the augmentation manager 140 is logically attached to the bookmarked content. Thus, when the consumer retrieves the content using its bookmark name, he may also navigate through the list of related sources and switch to view any of the related information. It will be appreciated that the bookmarked content and list of related sources may also be exported in a manner similar to the exporting of annotated content.

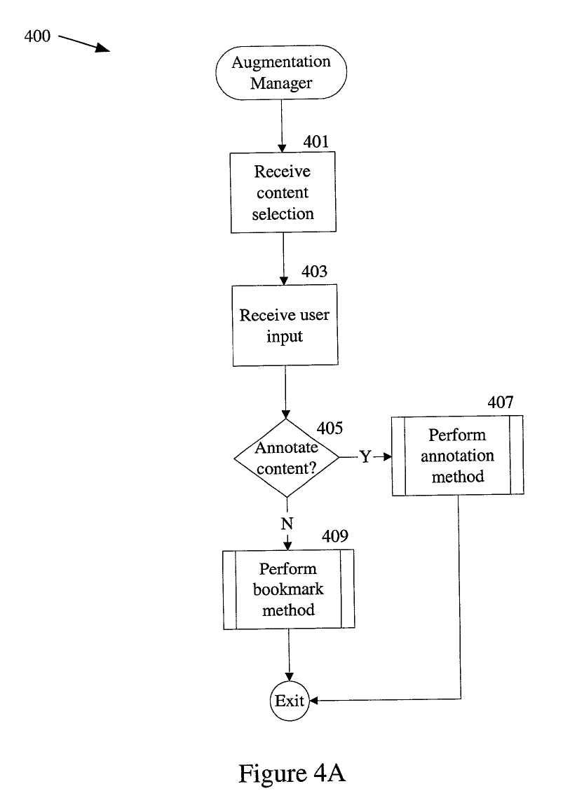

FIG. 2 shows exemplary logical blocks for the augmentation manager 140 according to one embodiment of the invention, including presentation module 210, augmentation module 220, augmentation retrieval module 230, an optional internal augmented content database 240, and augmentation export module 250. It will be appreciated that any non-volatile storage device accessible by the augmentation manager 140 may substitute for augmented content database 240.

The augmentation module 220 facilitates the user augmentation of multimedia content, which may be stored in the internal augmented content database 240 or other data store for later presentation by presentation module 210. The augmentation module 220 may annotate the content with user provided comments and information received through a graphical interface presented to the user by the presentation module 210. Existing annotations retrieved by the augmentation retrieval module 230 may be edited using the graphical interface provided by the presentation module 210, or exported using augmentation export module 250 to an external storage device, or to an external application module. The augmentation export module 250 may also post the augmentation content to an external network for access by others. For example, the presentation module 210 may display the list of annotations in a scrollable window so that the user can use the window's scroll bar to visually navigate the list. When the user finds the annotation he wants to edit or export, he selects the annotation, e.g. by clicking on the annotation using a remote control, and chooses an action to perform from a menu.

The augmentation module 220 also bookmarks user selected content for subsequent retrieval by the augmentation retrieval module 230, searches for related information, and stores the bookmark and a list of sources for the related information in the internal augmented content database 240 or other data store for later presentation by presentation module 210. When the user retrieves the bookmarked content, he can view the list of related sources and select one or more of the related sources. For example, the presentation module 210 may display the list of related sources in a scrollable window. When the user sees something on the list of interest, the user can switch to the related information by selecting the related source.

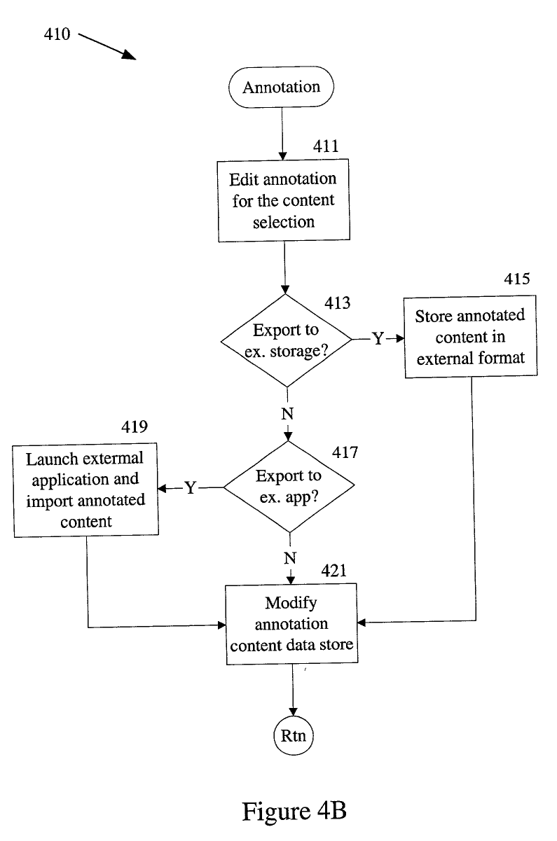

FIG. 3 illustrates a computer environment in which the present invention may be practiced. The augmentation manager 140 may execute on a computer system, such as computer system 40. The computer system 40, includes a processor 50, memory 55 and input/output capability 60 coupled to a system bus 65. The memory 55 is configured to store instructions which, when executed by the processor 50, perform the methods described herein. The memory 55 may also store content and augmentations. Input/output 60 provides for the delivery and display of the content and augmentations or portions or representations thereof. Input/output 60 also encompasses various types of computer-readable media, including any type of storage device that is accessible by the processor 50. One of skill in the art will immediately recognize that the term “computer-readable medium/media” further encompasses a carrier wave that encodes a data signal. It will also be appreciated that the computer system 40 is controlled by operating system software executing in memory 55. Input/output and related media 60 store the computer-executable instructions for the operating system and methods of the present invention as well as the content and augmentations. Input/output 60 may also include a network interface to enable the computer system 40 to connect to local and/or wide area networks.

The description of FIG. 3 is intended to provide an overview of computer hardware and other operating components suitable for implementing the invention, but is not intended to limit the applicable environments. It will be appreciated that the computer system 40 is one example of many possible computer systems which have different architectures. A typical computer system will usually include at least a processor, memory, and a bus coupling the memory to the processor. One of skill in the art will immediately appreciate that the invention can be practiced with other computer system configurations, including multiprocessor systems, minicomputers, mainframe computers, and the like. The invention can also be practiced in distributed computing environments where tasks are performed by remote processing devices that are linked through a communications network.

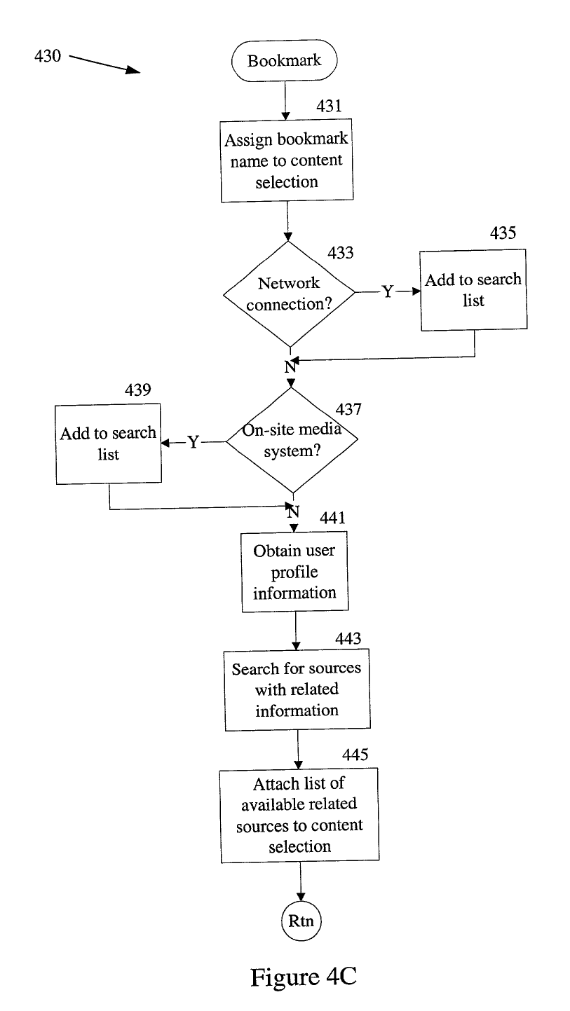

Turning now to FIGS. 4A-C, the particular methods of the invention are described in terms of computer software with reference to a series of flow diagrams. The methods constitute computer programs made up of computer-executable instructions illustrated as blocks (acts) 401 until 409, 411 until 421, and 431 until 445 in FIGS. 4A, 4B and 4C, respectively. Describing the methods by reference to a flow diagram enables one skilled in the art to develop such programs including such instructions to carry out the methods on suitably configured computers (the processor of the computer executing the instructions from computer-readable media, including memory). The computer-executable instructions may be written in a computer programming language or may be embodied in firmware logic. If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or a produce a result. It will be appreciated that more or fewer processes may be incorporated into the methods illustrated in FIGS. 4A-C without departing from the scope of the invention and that no particular order is implied by the arrangement of blocks shown and described herein.

Referring first to FIG. 4A, the acts to be performed by a computer executing one embodiment of an augmentation manager method 400 are shown. The method 400 receives a content selection (block 401) and input (block 403) from the user. If the user input specifies it is annotation information (block 405), the method 400 performs an annotation method (block 407) described next in conjunction with FIG. 4B. Otherwise the method 400 performs a bookmark method (block 409) described further below in conjunction with FIG. 4C. One of skill in the art will immediately understand that a user can both annotate and bookmark the same content using the method 400.

FIG. 4B is a flow diagram for the acts performed in an annotation method 410. The annotations for the multimedia content selection are edited at block 411 by adding a new annotation, or modifying or deleting an existing annotation. In one embodiment, a user interface guides the user in editing the content. A template is displayed to help the user enter a new annotation. A list of existing annotation for the content selection is displayed to the user, such as in a scrollable window so the user can use the window scroll bar to visually search for a particular entry. When the user indicates the editing is complete, the user specifies how to handle the annotated content.

If the annotated content is to be exported to an external device (block 413), the annotated content is stored in an external format that can be imported by other application, e.g., a plain ASCII file. Instead of storing the annotated content for subsequent use, the user may directly export the content to an external application (block 417). In this case, the external application is automatically launched and the annotated content is automatically imported into the external application at block 419. The annotated content is further stored to an annotated content data store, such as the internal database 240 in FIG. 2 (block 421).

FIG. 4C illustrates a bookmark method 430 that is performed when a user wishes to bookmark a content selection and search for related information. A bookmark identifier specified by the user is assigned to the content selection (block 431). The bookmark is typically a textual string representing a name that the user can easily remember. The bookmark can be assigned to any part of the content ranging from the complete content to individual frames and anything in between, e.g., a scene, a screenshot. In one embodiment, search criteria is formulated using information retrieved from metadata associated with the content. The available information depends on the chosen granularity of the bookmark. For example, if the granularity is a scene, information regarding that particular scene is retrieved from the content's metadata, e.g., the name of the city where the scene was shot, the names of all characters shown in the scene, etc.

If there is a network connection (block 433), the available networks are added to a search list (block 435). If there is an on-site media system (block 437), the available devices in the media system are added to the search list (block 439). The user's profile information is obtained to further refine the search parameters (block 441). At block 443, the method 430 uses the search list and the user profile to find available sources containing information related to the content selection. The actual execution of the search depends on the entity to be searched. For example, to search the Internet, the search criteria may be passed to any standard search engine to look for URL links that satisfy the criterion.

The results returned from the different entities are combined to form a complete list of related sources. The list of the available related sources is logically attached to the content selection (block 445).

It will be appreciated that the content may be stored separately from the annotations, bookmarks, and list of related sources. It will be further appreciated that, although not illustrated, the augmentation manager method 400 performs periodic maintenance on the annotated content and the bookmarks. If particular content is no longer stored, the corresponding annotations will be automatically purged. Similarly, the list of related sources is purged of invalid sources and newly found related sources may be added.

The annotation, bookmarking, and discovery of related information for multimedia content has been described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention. The terminology used in this application with respect to networks is meant to include all networking environments, including public and private, local and wide area, wired and wireless. Therefore, it is manifestly intended that this invention be limited only by the following claims and equivalents thereof.

### APPENDIX A

Ramin Aghevli, Reg. No. 43,462; William E. Alford, Reg. No. 37,764; Farzad E. Amini, Reg. No. 42,261; William Thomas Babbitt, Reg. No. 39,591; Jordan Michael Becker, Reg. No. 39,602; Michael A. Bernadicou, Reg. No. 35,934; Roger W. Blakely, Jr., Reg. No. 25,831; R. Alan Burnett, Reg. No. 46,149; Gregory D. Caldwell, Reg. No. 39,926; Jae-Hee Choi, Reg No. 45,288; Thomas M. Coester, Reg. No. 39,637; Robert P. Cogan, Reg. No. 25,049; Donna Jo Coningsby, Reg. No. 41,684; Florin Corie, Reg. No. 46,244; Mimi Diemmy Dao, Reg. No. 45,628; Dennis M. deGuzman, Reg. No. 41,702; Stephen M. De Klerk, Reg. No. 46,503; Michael Anthony DeSanctis, Reg. No. 39,957; Daniel M. De Vos, Reg. No. 37,813; Justin M. Dillon, Reg. No. 42,486; Sanjeet Dutta, Reg. No. 46,145; Matthew C. Fagan, Reg. No. 37,542; Tarek N. Fahmi, Reg. No. 41,402; Thomas S. Ferrill, Reg. No. 42,532; George Fountain, Reg. No. 37,374; Andre Gibbs, Reg. No. 47,593; James Y. Go, Reg. No. 40,621; Melissa A. Haapala, Reg No. 47,622; Alan Heimlich, Reg. No. 48,808; James A. Henry, Reg. No. 41,064; Libby H. Ho, Reg. No. 46,774; Willmore F. Holbrow III, Reg. No. 41,845; Sheryl Sue Holloway, Reg. No. 37,850; George W Hoover II, Reg. No. 32,992; Eric S. Hyman, Reg. No. 30,139; William W. Kidd, Reg. No. 31,772; Walter T. Kim, Reg. No. 42,731; Eric T. King, Reg. No. 44,188; Steve Laut, Reg. No. 47,736; George Brian Leavell, Reg. No. 45,436; Samuel S. Lee, Reg. No. 42791; Gordon R. Lindeen III, Reg. No. 33,192; Jan Carol Little, Reg. No. 41,181; Julio Loza, Reg. No. 47,758; Joseph Lutz, Reg. No. 43,765; Michael J. Mallie, Reg. No. 36,591; Andre L. Marais, Reg. No. 48,095; Paul A. Mendonsa, Reg. No. 42,879; Clive D. Menezes, Reg. No. 45,493; Richard A. Nakashima, Reg. No. 42,023; Stephen Neal Reg. No. 47,815; Chun M. Ng, Reg. No. 36,878; Thien T. Nguyen, Reg. No. 43,835; Thinh V. Nguyen, Reg. No. 42,034; Robert B. O'Rourke, Reg. No. 46,972; Daniel E. Ovanezian, Reg. No. 41,236; Gregg A. Peacock, Reg. No. 45,001; Marina Portnova, Reg. No. 45,750; Michael A. Proksch, Reg. No. 43,021; Randol W. Read, Reg. No. 43,876; William F. Ryann, Reg. 44,313; James H. Salter, Reg. No. 35,668; William W. Schaal, Reg. No. 39,018; James C. Scheller, Reg. No. 31,195; Jeffrey S. Schubert, Reg. No. 43,098; Saina Shamilov, Reg. No. 48,266; Maria McCormack Sobrino, Reg. No. 31,639; Stanley W. Sokoloff, Reg. No. 25,128; Judith A. Szepesi, Reg. No. 39,393; Ronald S. Tamura, Reg. No. 43,179; Edwin H. Taylor, Reg. No. 25,129; Lance A. Termes, Reg. No. 43,184; John F. Travis, Reg. No. 43,203; Kerry P. Tweet, Reg. No. 45,959; Mark C. Van Ness, Reg. No. 39,865; Tom Van Zandt, Reg. No. 43,219; Brent Vecchia, Reg No. 48,011; Lester J. Vincent, Reg. No. 31,460; Archana B. Vittal, Reg. No. 45,182; Glenn E. Von Tersch, Reg. No. 41,364; John Patrick Ward, Reg. No. 40,216; Mark L. Watson, Reg. No. 46,322; Thomas C. Webster, Reg. No. 46,154; and Norman Zafman, Reg. No. 26,250; my patent attorneys, and Charles P. Landrum, Reg. No. 46,855; Suk S. Lee, Reg. No. 47,745; and Raul Martinez, Reg. No. 46,904, Brent E. Vecchia, Reg. No. 48,011; Lehua Wang, Reg. No. P48,023; my patent agents, of BLAKELY, SOKOLOFF, TAYLOR & ZAFMAN LLP, with offices located at 12400 Wilshire Boulevard, 7th Floor, Los Angeles, Calif. 90025, telephone (310) 207-3800, and James R. Thein, Reg. No. 31,710, my patent attorney with full power of substitution and revocation, to prosecute this application and to transact all business in the Patent and Trademark Office connected herewith.

### APPENDIX B

### Title 37, Code of Federal Regulations, Section 1.56 Duty to Disclose Information Material to Patentability

(a) A patent by its very nature is affected with a public interest. The public interest is best served, and the most effective patent examination occurs when, at the time an application is being examined, the Office is aware of and evaluates the teachings of all information material to patentability. Each individual associated with the filing and prosecution of a patent application has a duty of candor and good faith in dealing with the Office, which includes a duty to disclose to the Office all information known to that individual to be material to patentability as defined in this section. The duty to disclose information exists with respect to each pending claim until the claim is cancelled or withdrawn from consideration, or the application becomes abandoned. Information material to the patentability of a claim that is cancelled or withdrawn from consideration need not be submitted if the information is not material to the patentability of any claim remaining under consideration in the application. There is no duty to submit information which is not material to the patentability of any existing claim. The duty to disclose all information known to be material to patentability is deemed to be satisfied if all information known to be material to patentability of any claim issued in a patent was cited by the Office or submitted to the Office in the manner prescribed by §§1.97(b)-(d) and 1.98. However, no patent will be granted on an application in connection with which fraud on the Office was practiced or attempted or the duty of disclosure was violated through bad faith or intentional misconduct. The Office encourages applicants to carefully examine:

(1) Prior art cited in search reports of a foreign patent office in a counterpart application, and

(2) The closest information over which individuals associated with the filing or prosecution of a patent application believe any pending claim patentably defines, to make sure that any material information contained therein is disclosed to the Office.

(b) Under this section, information is material to patentability when it is not cumulative to information already of record or being made of record in the application, and

(1) It establishes, by itself or in combination with other information, a prima facie case of unpatentability of a claim; or

(2) It refutes, or is inconsistent with, a position the applicant takes in:

(i) Opposing an argument of unpatentability relied on by the Office, or

(ii) Asserting an argument of patentability.

A prima facie case of unpatentability is established when the information compels a conclusion that a claim is unpatentable under the preponderance of evidence, burden-of-proof standard, giving each term in the claim its broadest reasonable construction consistent with the specification, and before any consideration is given to evidence which may be submitted in an attempt to establish a contrary conclusion of patentability.

(c) Individuals associated with the filing or prosecution of a patent application within the meaning of this section are:

(1) Each inventor named in the application;

(2) Each attorney or agent who prepares or prosecutes the application; and

(3) Every other person who is substantively involved in the preparation or prosecution of the application and who is associated with the inventor, with the assignee or with anyone to whom there is an obligation to assign the application.

(d) Individuals other than the attorney, agent or inventor may comply with this section by disclosing information to the attorney, agent, or inventor.

(e) In any continuation-in-part application, the duty under this section includes the duty to disclose to the Office all information known to the person to be material to patentability, as defined in paragraph (b) of this section, which became available between the filing date of the prior application and the national or PCT international filing date of the continuation-in-part application.

What is claimed is:

1. A method of augmenting multimedia content by a user comprising:
receiving a content selection from the user;
receiving an augmentation from the user; and
associating the augmentation with the content selection.

2. The method of claim 1, wherein the augmentation is an annotation and further comprising storing the annotation.

3. The method of claim 2 further comprising:
displaying a list of annotations for the content selection to the user;
receiving an annotation selection from the user;
receiving editing data from the user; and
editing the annotation selection according to the editing data.

4. The method of claim 2 further comprising:
storing the annotation and the content selection in a format suitable for use by an external application.

5. The method of claim 2 further comprising:
exporting the annotation and the content selection to an external application.

6. The method of claim 1, wherein the augmentation is a bookmark and further comprising:
determining related sources with information related to the selected content; and
associating the related sources with the bookmark.

7. The method of claim 6 further comprising:
displaying the related sources when the bookmark is accessed by the user;
receiving a source selection from the user; and
displaying information from the source selection to the user.

8. The method of claim 6, wherein determining related sources comprises:
examining a profile of the user;
determining if a remote network connection is available; and
determining if a local network device is available.

9. The method of claim 6 further comprising:
storing the bookmark, the related sources, and the content selection in a format suitable for use by an external application.

10. The method of claim 6 further comprising:
exporting the bookmark, the related sources, and the content selection to an external application.

11. A computer-readable medium having executable instructions to cause a computer to perform a method comprising:
receiving a content selection from a user;
receiving an augmentation from the user; and
associating the augmentation with the content selection.

12. The computer-readable medium of claim 11, wherein the augmentation is an annotation and the method further comprises storing the annotation.

13. The computer-readable medium of claim 12, wherein the method further comprises:
displaying a list of annotations for the content selection to the user;
receiving an annotation selection from the user;
receiving editing data from the user; and
editing the annotation selection according to the editing data.

14. The computer-readable medium of claim 12, wherein the method further comprises:
storing the annotation and the content selection in a format suitable for use by an external application.

15. The computer-readable medium of claim 12, wherein the method further comprises:
exporting the annotation and the content selection to an external application.

16. The computer-readable medium of claim 11, wherein the augmentation is a bookmark and the method further comprises:
determining related sources with information related to the selected content; and
associating the related sources with the bookmark.

17. The computer-readable medium of claim 16, wherein the method further comprises:
displaying the related sources when the bookmark is accessed by the user;
receiving a source selection from the user; and
displaying information from the source selection to the user.

18. The computer-readable medium of claim 16, wherein determining related sources comprises:
examining a profile of the user;
determining if a remote network connection is available; and
determining if a local network device is available.

19. The computer-readable medium of claim 16, wherein the method further comprises:
storing the bookmark, the related sources, and the content selection in a format suitable for use by an external application.

20. The computer-readable medium of claim 16, wherein the method further comprises:
exporting the bookmark, the related sources, and the content selection to an external application.

21. A computer system comprising:
a processor coupled to a memory through a bus; and
an augmentation process executed by the processor from the memory to cause the processor to receive a content selection and an augmentation from a user and associate the augmentation with the content selection.

22. The computer system of claim 21, wherein the augmentation is an annotation and the augmentation process further causes the processor to store the annotation.

23. The computer system of claim 22, wherein the augmentation process further causes the processor to display a list of annotations for the content selection to the user, to receive an annotation selection and editing data from the user, and edit the annotation selection according to the editing data.

24. The computer system of claim 22, wherein the augmentation process further causes the processor to store the annotation and the content selection in a format suitable for use by an external application.

25. The computer system of claim 22, wherein the augmentation process further causes the processor to export the annotation and the content selection to an external application.

26. The computer system of claim 21, wherein the augmentation is a bookmark and the augmentation process further causes the processor to determine related sources with information related to the selected content, and associate the related sources with the bookmark.

27. The computer system of claim 26, wherein the augmentation process further causes the processor to display the related sources when the bookmark is accessed by the user, receive a source selection from the user, and display information from the source selection to the user.

28. The computer system of claim 26, wherein the augmentation process further causes the processor to examine a profile of the user, determine if a remote network connection is available, and determine if a local network device is available to determine the related sources.

29. The computer system of claim 26, wherein the augmentation process further causes the processor to store the bookmark, the related sources, and the content selection in a format suitable for use by an external application.

30. The method of claim 26, wherein the augmentation process further causes the processor to export the bookmark, the related sources, and the content selection to an external application.

31. A system for augmenting multimedia content by a user comprising:
a presentation module to present a graphical interface to the user when the user selects content;
an augmentation module to augment content selected by the user;
an augmentation retrieval module to retrieve existing augmentations for the content selected by the user; and
an augmentation export module to export an augmentation for the content selected by the user.

32. The system of claim 31 further comprising:
an augmented content database containing augmentations for the content selected by the user.
